(19) United States
(12) Patent Application Publication
(10) Pub. No.: US 2021/0049621 A1
(43) Pub. Date: Feb. 18, 2021

(54) SYSTEM AND METHOD FOR INTELLIGENT CUSTOMER RELATIONSHIP MANAGEMENT DATA MIGRATION

(71) Applicant: Introhive Services Inc., Fredericton (CA)

(72) Inventors: Jody GLIDDEN, Miami Beach, FL (US); Brandon HUBBARD, Fredericton (CA); Jonathan ATKINSON, Rusagonis (CA); Jacob O'REILLY, Fredericton (CA); Silvio VERZILLI, Fredericton (CA); Steve RODERICK, Saint John (CA)

(21) Appl. No.: 16/993,244

(22) Filed: Aug. 13, 2020

Related U.S. Application Data
(60) Provisional application No. 62/886,006, filed on Aug. 13, 2019.
(60) Provisional application No. 62/892,211, filed on Aug. 27, 2019.

(51) Int. Cl. G06Q 30/02; G06F 16/903

(52) U.S. Cl. CPC G06Q 30/0201; G06F 16/903

(57) ABSTRACT

A method and system for migrating contact data from a source customer relationship management (CRM) system to a target CRM system, comprising retrieving a source contact record corresponding to a source contact from a source CRM database associated with the source CRM system, the source contact record including a first set of data fields populated with information about the source contact; retrieving, from a support database, a support contact record corresponding to the source contact, the support contact record including a second set of data fields populated with information about the source contact; and determining, based on information included in the support contact record, if the source contact record meets a predefined migration criteria, and if so perform a migration process to migrate information included in the source contact record to the target CRM system.

### CROSS-REFERENCE TO RELATED APPLICATIONS

This application claims the benefit of and priority to the following applications, the contents of which are incorporated herein by reference: (1) U.S. Provisional Patent Application No. 62/886,006 entitled “SYSTEM AND METHOD FOR SELECTIVE CRM DATA MIGRATION”, filed Aug. 13, 2019; (2) U.S. Provisional Patent Application No. 62/892,211 entitled “SYSTEM AND METHOD FOR DATA MAPPING SUGGESTIONS DURING DATA MIGRATION”, filed Aug. 27, 2019.

### TECHNICAL FIELD

The present disclosure relates to systems and methods for processing digital information from a Customer Relationship Management (CRM) system and intelligently transitioning that information into another Customer Relationship Management (CRM) system.

### BACKGROUND

Enterprises such as companies, accounting firms, law firms, universities, partnerships, agencies and governments commonly use CRM systems and related technology to manage relationships and interactions with other parties such as customers and potential customers. In particular, CRM systems typically employ electronic computing and communications devices that enable one or more of contact management, sales management and calendar management with the objective of enhancing productivity. An important function provided by CRM systems is digital tracking and storage of data about third parties such as customers and potential customers.

Scenarios can arise that require data from one CRM system to be migrated to a different CRM system. For example, if an enterprise that is supported by a CRM system purchases or merges with another enterprise that has its own CRM system then it is often desirable to migrate the data to one common CRM.

However, CRM data migration can be challenging as different CRM systems (e.g., CRM systems from different CRM solution providers, or CRM systems that are from the same solution provider but have different data configurations) can store contact data differently. If an enterprise wishes to convert or merge CRM databases from different CRM systems, they may find that different CRM systems can have different default data fields as well as different custom data fields.

Another data migration challenge is that not all of the contact data within a source CRM system that is being migrated is desirable to maintain or considered valuable. In existing solutions, contact data may be excluded based on an age of the data, which is a narrow criteria for assessing contact data value, or through extensive manual review.

Another data migration challenge can arise when processing duplicate contact records. Each CRM system may have different pieces of the contact's data (as well as overlapping pieces).

According, there is a need for a CRM migration system that addresses one or more the challenges identified above.

The foregoing examples of the related art and limitations thereto are intended to be illustrative and not exclusive. Other limitations of the related art will become apparent to those of skill in the art upon a reading of the specification and a study of the drawing.

### SUMMARY

According to a first example aspect is a computer implemented method for migrating contact data from a source customer relationship management (CRM) system to a target CRM system that comprises a plurality of target contact records that each include a target set of data fields populated with information about a respective existing contact. The method comprises retrieving a source contact record corresponding to a source contact from a source CRM database associated with the source CRM system, the source contact record including a first set of data fields populated with information about the source contact; retrieving, from a support database, a support contact record corresponding to the source contact, the support contact record including a second set of data fields populated with information about the source contact; and determining, based on information included in the support contact record, if the source contact record meets a predefined migration criteria, and if so perform a migration process to migrate information included in the source contact record to the target CRM system.

In one or more of the preceding aspects, the predefined migration criteria includes one or more metrics that are indicative of a perceived value of the source contact.

In one or more of the preceding aspects, the metrics indicative of the perceived value of the source contact include one or both of (i) a threshold relationship score that indicates a perceived value of a relationship with the source contact based on a communication activities associated with the source contact, and (ii) a threshold title score that indicates a position of the source contact.

In one or more of the preceding aspects, one or both of a relationship score and a title score of the source contact are indicated in the support contact record.

In one or more of the preceding aspects, the predefined migration criteria include one or more of the following in respect of the source contact: (i) a minimum relationship score; (ii) a minimum title score; (iii) a specific industry to include for migration; (iv) a specific organization to include for migration; (v) a specific organization to exclude from migration; and (vi) a minimum completeness score for the first set of data fields. In one or more of the preceding aspects, the migration process comprises: merging information from the first set of data fields and the second set of data fields in accordance with a predefined mapping policy that defines a set of predefined rules for mapping the source contact record to the target CRM system and a predefined object map, the predefined object map mapping at least some of the data fields of the first set of data fields to corresponding data fields of the target set of data fields; and when the first set of data fields includes unmapped fields that have not been mapped to a corresponding data field in the target set of data fields: automatically determining a suggested mapping for one or more of the unmapped fields; presenting the suggested mapping to a data steward for approval; and applying the suggested mapping as approved by the data steward to map at least one of the unmapped fields to a corresponding data field in the target set of data fields.

In one or more of the preceding aspects, automatically determining the suggested mapping for one or more of the unmapped fields comprises matching unmapped fields to one or more data fields in the target set of data fields based on the format of the data included in the fields.

In one or more of the preceding aspects, automatically determining the suggested mapping for one or more of the unmapped fields comprises matching unmapped fields to one or more data fields in the target set of data fields based on similarities in names of the fields.

In one or more of the preceding aspects, the migration process comprises determining if the source contact record corresponds to a target contact record that corresponds to an existing contact that is the same individual as the source contact, and if so, performing a duplicate record processing process in accordance with the predefined mapping policy.

In a further example aspect, a computer system is disclosed that is configured to implement the method of one or more of the preceding aspects.

### BRIEF DESCRIPTION OF DRAWINGS

Exemplary embodiments are illustrated in the referenced figures of the drawings. It is intended that the embodiments and figures disclosed herein are to be considered illustrative rather than restrictive.

FIG. 1 is a simplified block diagram illustrating an environment that includes a client network, a CRM support system, and a CRM system, in accordance with an example embodiment of the present disclosure.

FIG. 2 is a simplified block diagram illustrating a CRM migration environment that includes a CRM migration system, a CRM support system, a source CRM system and a target CRM system, in accordance with an example embodiment of the present disclosure.

FIG. 3 illustrates a side by-side comparison of illustrative contact records formats used for the source and target CRM systems.

FIG. 4 is a flow diagram illustrating a process performed by the migration system of FIG. 1, according to an example embodiment.

FIG. 5 is a flow diagram illustrating a process performed by a mapping module of the migration system of FIG. 1, according to an example embodiment.

FIG. 6 is a simplified block diagram illustrating an example computer system for implementing one or more of the systems, modules and components shown in the environment of FIG. 1.

### DESCRIPTION

The following embodiments and aspects thereof are described and illustrated in conjunction with systems, tools and methods which are meant to be exemplary and illustrative, not limiting in scope. In various embodiments, one or more of above-described challenges have been reduced or eliminated, while other embodiments are directed to other improvements.

Embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

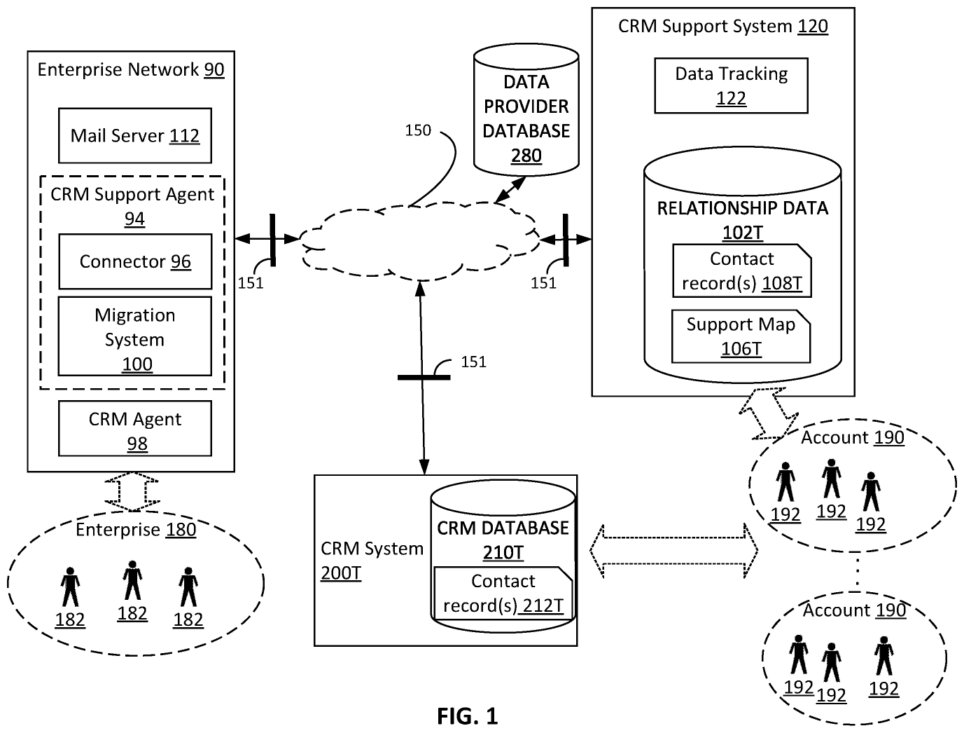

In at least some example embodiments, the CRM migration system and method described in this disclosure relies on information provided by a CRM support system. Accordingly, an environment that incorporates a CRM support system 120 as shown in FIG. 1 will be described to provide context prior to a detailed description of a CRM migration system and method.

FIG. 1 illustrates an example environment in which a CRM support system 120 may be implemented. In the example of FIG. 1, the environment includes CRM support system 120, enterprise network 90, and a CRM system 200T. Each of enterprise network 90, CRM support system 120 and CRM database system 200T may, for example, include a plurality of computer devices, servers and systems that are linked to each other through one or more internal or external communication networks.

Enterprise network 90 supports an enterprise such as a company, firm or other type of organization (referred to in this disclosure as “enterprise 180”). In example embodiments, a plurality of individuals are registered or otherwise associated with the enterprise network 90 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time the enterprise 180 has, or is, pursuing commercial relationships with one or more external entities, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. In some examples, a large customer organization may have multiple divisions or groups that each are treated as a respective account 190 by enterprise 180. Typically, each account 190 will have an associated set of individual contacts, referred to in this disclosure as “contacts” 192. For example, the individual contacts 192 associated with an account 190 may be employees, owners, partners, consultants, volunteers, and interns of the account 190.

One or both of CRM support system 120 and CRM system 120 may, in some examples, be operated by third party organizations that are service providers to the enterprise 180 associated with enterprise network 90. CRM support system 120 and a CRM system 200T are configured to track customer data on behalf of enterprise 180.

In the illustrated example, enterprise network 90, CRM support system 120, and CRM system 200T are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 90, CRM support system 120, and CRM system 200T. In different example embodiments, one or more of the features or functions of CRM support system 120 and CRM system 200T that are described herein could be alternatively be implemented in a common system or implemented within the enterprise network 90. For example, in some examples, one or both of CRM support system 120 and CRM system 200T could be incorporated into enterprise network 90.

Enterprise network 90 includes at least one mail server 112 for handling and delivering external email that enterprise network 90 exchanges with remote mail servers through communication network 150. Thus, mail server 112 contains emails sent/received by the enterprise 180 associated with enterprise network 90. In some examples, mail server 112 may also handle internal emails that are internal within enterprise network 90.

In example embodiments, enterprise network 90 includes a CRM agent 98 that provides the enterprise network 90 with an interface to CRM system 200T. In example embodiments, enterprise network 90 also includes a CRM support agent 94 that provides the enterprise network 90 with an interface to CRM support system 120. In example embodiments, CRM support agent 94 includes a connector 96 and a migration system 100. Connector 96 is configured to interact with systems within the enterprise network 90 (such as mail server 112 and CRM agent 98) to extract information about contacts and activities (such as communication activities) and provide that information to CRM support system 120. As will also be described in greater detail below, migration system 100 is configured to support migration of contact data from a source CRM system to a destination or target CRM system.

In example embodiments, CRM system 200T may be implemented using a known CRM solution such as, but not limited to, Salesforce.com™, Microsoft Dynamics™, InterAction™ or Maximizer™, and includes a CRM database 210 that includes customer data (e.g., CRM data) for accounts 190 is desirous of tracking. The CRM data that is stored in a CRM database 200T for an account 190 may for example include: (I) general account data, and (II) individual contact data that includes contact information for individual contacts 192 who are members of the account 190. Individual contact data may be organized as a plurality of contact records 212T. By way of non-limiting example, the contact record 212T for a particular individual contact 192 may include or link to the set of attribute data fields identified in the following Table 1:

TABLE 1
CRM Target Contact Record 212T Data Fields:

| Field | |
|---|---|
| (Default fields indicated | |
| by “*”) | Field Description |
| 1. CRM Contact ID* | Unique contact identifier for |
| | individual contact 192 |
| 2. Date Created* | Date contact added |
| 3. Account ID* | Unique identifier assigned to the |
| | account 190 the contact 192 |
| | represents |
| 4. Company ID* | Unique identifier assigned to the |
| | company that account 190 is part of |
| | (e.g., large company may have |
| | multiple accounts) |
| 5. Account Industry Code* | Code that identifies primary industry |
| | type of account (e.g., Standard |
| | Industrial Classification (SIC) Code |
| | and/or North American Industry |
| | Classification System (NAICS) |
| | Codes) |
| 6. Title* | Position/title of contact 192 |
| 7. Full Name (First Name, | Contact's Full Name |
| Middle Name, Last Name)* | |
| 8. Primary Email* | Contact's Primary Email Address |
| 9. Work Phone* | Contact's Primary Phone Number |
| 10. Mobile Phone* | Contact's Mobile Phone Number |
| 11. Social Media URL | Contact's Linked-In ™, Instagram ™, |
| Link(s)* | Twitter ™ or Similar URL Links |
| 12. Custom Field A | Custom CRM Field |
| 13. Custom Field B | Custom CRM field |

In an illustrative embodiment, the CRM system 200T is provided by a known CRM solution provider (e.g., “CRM provider A”). CRM solutions from CRM provider A use a default format for contact records 212T that includes a set of default fields 1 to 11, indicated by asterisks (*) in Table 1. Additionally, the contact records 212T may also include a set of one or more custom fields (e.g., “12. Custom Field A”; “13. Custom Field B”) that have been specifically configured for the CRM solution that is provided to a particular enterprise 180.

In example embodiments, CRM support system 120 is configured to provide enhanced CRM information and functionality that supplements CRM System 200T. CRM support system 120 includes a CRM support database, relationship data storage 102T, for storing relationship data generated in respect of the accounts 190 of interest to enterprise 180. The data in relationship data storage 102T may include some or all of the customer information stored at CRM database 210T, as well as supplemental information. In example embodiments, similar to CRM database 210T, relationship data storage 102T may store individual contact data that includes contact information for individual contacts 192 (e.g., employees) who are associated with accounts 190. Individual contact data may be organized as a plurality of support contact records 212T. By way of non-limiting example, the support contact record 108T for a particular individual contact 192 may include or link to the set of attribute data fields identified in the following Table 2:

TABLE 2
CRM Support Contact Record 108T Data Fields:

| Field | |
|---|---|
| (Default fields indicated | |
| by “*”) | Field Description |
| 1. CRM Support Contact ID* | Unique CRM Support system ID for |
| | individual contact 192 |
| 2. CRM Contact ID* | CRM ID for individual contact 192 |
| 3. Account ID* | Unique identifier assigned to |
| | account 190 associated with contact |
| | 192 represents |
| 4. Company ID* | Unique identifier assigned to the |
| | company that account 190 is part |
| | of. |
| 5. Account Industry Code* | Code that identifies primary industry |
| | type of account |
| 6. Title* | Position/title of contact 192 |
| 7. Title Score* | Score assigned to Contact based on |
| | contact's position at the account |
| | organization (e.g., President = 10 |
| | points, Vice president = 8 points, |
| | Sales Manager = 6 points, etc., (may |
| | be defined in a look-up-table (LUT)) |
| 8. Full Name* | Contact's Full Name |
| 9. Primary Email* | Contact's Primary Email Address |
| 10. Work Phone* | Contact's Primary Phone Number |
| 11. Mobile Phone* | Contact's Mobile Phone Number |
| 12. Social Media Link(s)* | Contact's Linked-In ™, Instagram ™, |
| | Twitter ™ or Similar Links |
| 13. Contact Relationship | Score That Indicates Perceived |
| Score* | Value of the Relationship With |
| | Contact 192 |
| 14. Custom Field A | Custom Field |
| 15. Custom Field B | Custom Field |

In the illustrated embodiment, CRM Support Contact Records 108T include a set of default fields (e.g., fields 1-13), as well as a set of one or more custom fields (e.g., “12. Custom Field A”; “13. Custom Field B”) that have been specifically configured for the CRM support solution that is provided to a particular enterprise 180.

As can be seen in Tables 1 and 2, the contact records 108T maintained by CRM support system 120 can include the same attribute fields as contained in contact records 212T of CRM system 200T, as well additional fields (e.g., 1. CRM Support Contact ID; 7. Title Score; and 13. Contact Relationship Score). In at least some examples, the contact records 108T of CRM support system 120 both duplicate and supplement the information included in the contact records 212T of CRM system 200T. In at least some examples, CRM support system 120 is brought online for enterprise 180 at the same time as CRM system 200T and the systems are populated in parallel. CRM support system 120 stores a CRM system 200T-CRM support system 120 attribute map 106T (hereafter “support map 106T) that maps the fields of contact record 212T format to the corresponding fields of contact record 108T format, including custom fields. In some examples, CRM support system 120 may be brought online for enterprise 180 at some point after CRM system 200T is brought online, in which case an initialization process that includes migration of contact records from the CRM database 210T to the relationship data 102T can be performed according to the CRM system 200T-CRM support system 120 map 106.

In example embodiments, the ongoing collection and updating of data stored in relationship data storage 102T is facilitated by a data tracking module 122 of the CRM Support System 120 that interfaces with the connector 96 of CRM support agent 94 and other possible data sources such as a third party data provider database 280. In some examples, the data tracking module 122 of CRM support system 120 is configured to periodically refresh (e.g., for example on a timed cycle such as once every 24 hours) the data stored in relationship data storage 102T such that the data includes current or near-current information. The data tracking module 122 may periodically refresh the information stored in relationship data storage 102 based on information from a plurality of sources. For example, CRM support system 120 may obtain data indirectly or directly from the CRM system 200T, from enterprise network 90, from one or more third party data provider database(s) 280, as well as from other data sources that are available through communication network 150.

In addition to updating contact records 108T, in example embodiments the data tracking module 122 may also track and store activity data in relationship data storage 102T. Activities may for example include communication activities. Activity data may include respective activity records for each logged activity. Each activity record may include, depending on the type of activity and availability of information, the variable fields listed in the following Table 6, among other things:

TABLE 3
Activity Record Fields:

| Field | Field Description |
|---|---|
| Activity ID | Unique identifier assigned to activity |
| Account ID | Identity of Account whose contacts |
| | participated in the activity |
| Activity Type Indicator | Value that identifies the type of |
| | activity (e.g., (i) communication |
| | activity: incoming email, outgoing |
| | email, incoming meeting request, |
| | outgoing meeting request, incoming |
| | phone call, outgoing phone call, in- |
| | person meeting, virtual meeting, (ii) |
| | documentation activity: proposal |
| | submitted, draft statement of work |
| | (SOW) submitted; final SOW |
| | submitted; contract submitted for |
| | review). |
| Start Time | Date and time stamp indicating start |
| | of activity |
| Activity Duration | Duration of activity (e.g., length of |
| | meeting or phone call) |
| Participants - Account* | Contact IDs or other available |
| | identifier for all parties involved on |
| | account side of activity |
| Participants - Enterprise* | User IDs or other available identifier |
| | for all parties involved on enterprise |
| | side of activity |

(*) Indicates fields that will be repeated as required

In example embodiments, the CRM support system 120 is configured to log and record changes that occur in one or more of the variable fields so that changes in data can be tracked over time. Activity data is inherently dynamic as new activity records are continuously generated in respect of an opportunity.

In example embodiments, at least some of the activity records, such as activity records generated in respect of communication activities, are generated and at least partially populated based on information generated through automated tracking of electronic events that occur at enterprise network 90. Some activity records may, in at least some examples, be generated in response to information provided by a user 182 through an interface supported by CRM support agent 94, which is then relayed to CRM support system 120 through communication network 150.

In example embodiments, connecter 96 is configured to automatically collect information about communication activities between users 182 associated with the enterprise 180 and external contacts 192 associated with an account 190. These communication activities may, for example, be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the member(s) 182 of the enterprise 180 that were involved in the interaction.

In some examples, connector 96 may be configured to communicate directly with calendar applications of users 182 within the enterprise network 90 to identify email addresses belonging to possible external contacts, and include that information in communication activity data. In some examples where enterprise network 90 supports phone call logging, for example in Voice-Over-Internet-Protocol (VOIP) implementations, connector 96 may be further configured to interact with a VOIP server to collect information about external phone numbers used for outgoing and internal calls for inclusion in communication activity data.

As noted above, in example embodiments the contact record 108T for a contact includes a Contact Relationship Score fields that indicates a perceived relationship value of a contact 192. In at least some examples, this value is calculated by CRM support system 120 based on the communication activities between enterprise 180 and the contact 192. By way of example, the Contact Relationship Score for a contact may be based on attributes selected from the following table:

TABLE 4
Communication Activity Attributes:

| Field | Field Description |
|---|---|
| Incoming Emails | Number of incoming emails in a |
| | defined period (e.g., from Contact to |
| | Enterprise). |
| Outgoing Emails | Number of outgoing emails in a |
| | defined period (e.g. from Enterprise |
| | to Contact). |
| Ratio of Incoming to | Based on above two attributes |
| Outgoing Emails | |
| Email Response Time- | Average Time to respond to |
| Enterprise | incoming email from Account |
| Email Response Time- | Average Time for contact to respond |
| Contact | to email from Enterprise |
| Number of Phone | Number of meetings with contact by |
| Calls/Meetings | phone or video conference or in- |
| | person in a defined period |
| Meeting Duration | Average duration of meetings with |
| | contact |

Using the above attributes, the Contact Relationship Score for a contact could based on features such as, among other things: activity type (e.g., incoming email, outgoing email, incoming meeting request, outgoing meeting request, incoming phone call, outgoing phone call, in-person meeting, on-line meeting, video conference); frequency (e.g., number of communication activities with a defined time period); recentness of communication activities; length of communication activity; and sentiment of communication activity. For example, a Contact Relationship Score could be quantified as a percentage (e.g., 0 to 100%) by applying a predetermined function, which may in some example be a deterministic linear rules-based model, and in other examples may be a trained non-linear predictive model. In example embodiments, a deterministic model may be derived by a data scientist based analysis of simulated data and real data using one or more statistical analysis methods. In some example embodiments, Contact Relationship Score could be represented as a qualitative value such as “high”, “medium, “low”.

In some examples a Contact Relationship Score could be a composite of the contacts title score and a communication value based on the above attributes.

Migration Scenario

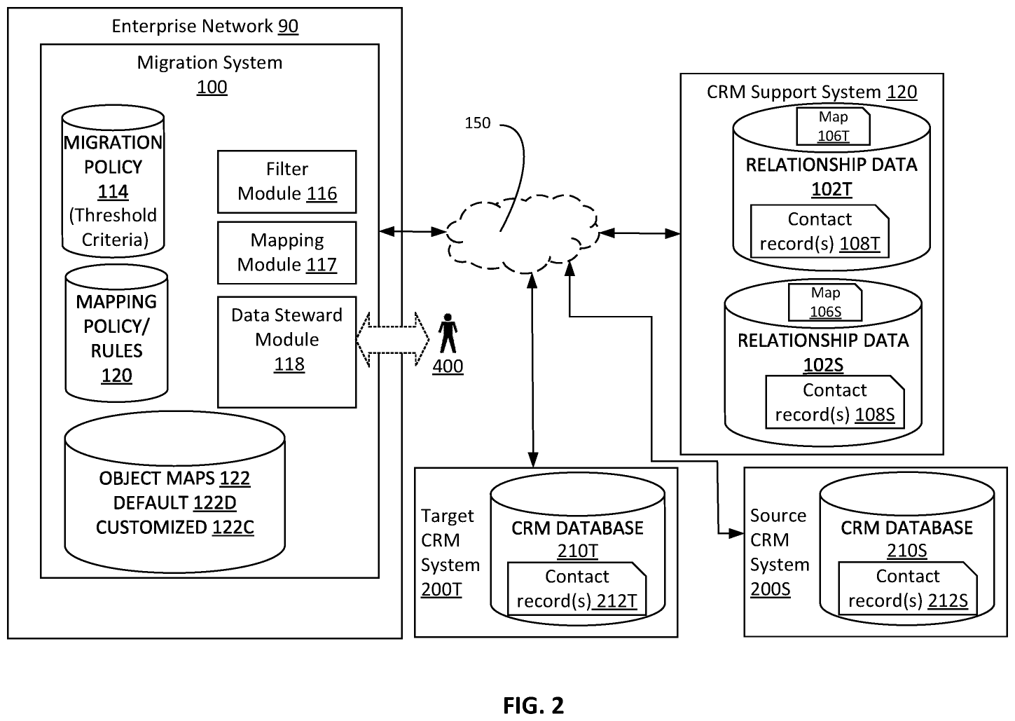

FIG. 2 illustrates a further view of an example environment in which the methods and systems described in this disclosure may be implemented. In the example of FIG. 2, the migration system 100 that is included in the CRM support agent 94 is shown in greater detail and other components previously described in respect of FIG. 1 have been omitted for simplicity. FIG. 2 illustrates an example scenario where the above noted enterprise 180 desires to merge the information included in the databases of two different CRM systems, namely the data included CRM database 210S of a source CRM system 200S and the data included in previously described CRM database 210T of CRM system 200T (hereafter referred to as “target” CRM database 210T of “target” CRM system 200T). Such a scenario may arise for example in a situation where enterprise 180, which as noted above is supported by target CRM system 200T, has acquired or merged with a further enterprise that is supported by a different CRM system, namely source CRM system 200T. In order to avoid using and maintaining two isolated CRM systems 200T, 200S, enterprise desires to consolidate all contact data into a single CRM system by migrating the source contact records 212S over to the target CRM system 200T.

As noted above, such migration can face a variety of challenges. For example, the contact data included in target contact records 212T may be in a different format and include different attribute fields than the source contact records 212S. Furthermore, there may be overlap in the contacts 192 included in the contact records of the respective CRM systems. Additionally, enterprise may want to exclude from the migration process contact data in source CRM database 210S that is of no value or interest or is protected by confidentiality or privacy obligations.

As noted above, in an illustrative embodiment, the target CRM system 200T is provided by a known CRM solution provider, “CRM provider A”. In various sceneries, the source CRM system 200S may, among other possibilities, be: (i) provided by the same CRM provider A, with the source contact record 212S format including the same default and custom attribute fields as the target contact record 212T format; (ii) provided by the same CRM provider A, with the source contact record 212S format including the same default attribute fields but different custom attribute fields as the target contact record 212T format; (iii) provided by a different CRM provider (e.g. “CRM provider B”) with the source contact record 212S format including default attribute fields and custom attribute fields that are both different than the target contact record 212T format.

An example of scenario (iii) (e.g., CRM systems 200T, 200S are provide by different CRM providers A and B, respectively), may for example result in the set of attribute data fields included in a source CRM contact record 212S for a particular individual contact being as shown in Table 5 below:

TABLE 5
Source CRM Contact Record 212S Data Fields:

| Field | |
|---|---|
| (Default fields indicated | |
| by “*”) | Field Description |
| 1. CRM Contact ID* | Unique contact identifier for |
| | individual contact 192 |
| 2. Date Created* | Date contact added |
| 3. Company-Account ID* | Unique identifier assigned to the |
| | company and account 190 the |
| | contact 192 represents |
| 4. Account Industry Code* | Code that identifies primary industry |
| | type of account (e.g., Standard |
| | Industrial Classification (SIC) Code |
| | and/or North American Industry |
| | Classification System (NAICS) |
| | Codes) |
| 5. Title* | Position/title of contact 192 |
| 6. Full Name (Last Name, | Contact's Full Name |
| First Name, Middle | |
| initial)* | |
| 7. Primary Email* | Contact's Primary Email Address |
| 8. Cell Phone* | Contact's Mobile Phone Number |
| 9. Landline Phone* | Contact's Primary Phone Number |
| 10. Social Media URL | Contact's Linked-In ™, Instagram ™, |
| Link(s)* | Twitter ™ or Similar URL Links |
| 11. Custom Field A1 | Custom CRM Field |
| 12. Custom Field B1 | Custom CRM field |

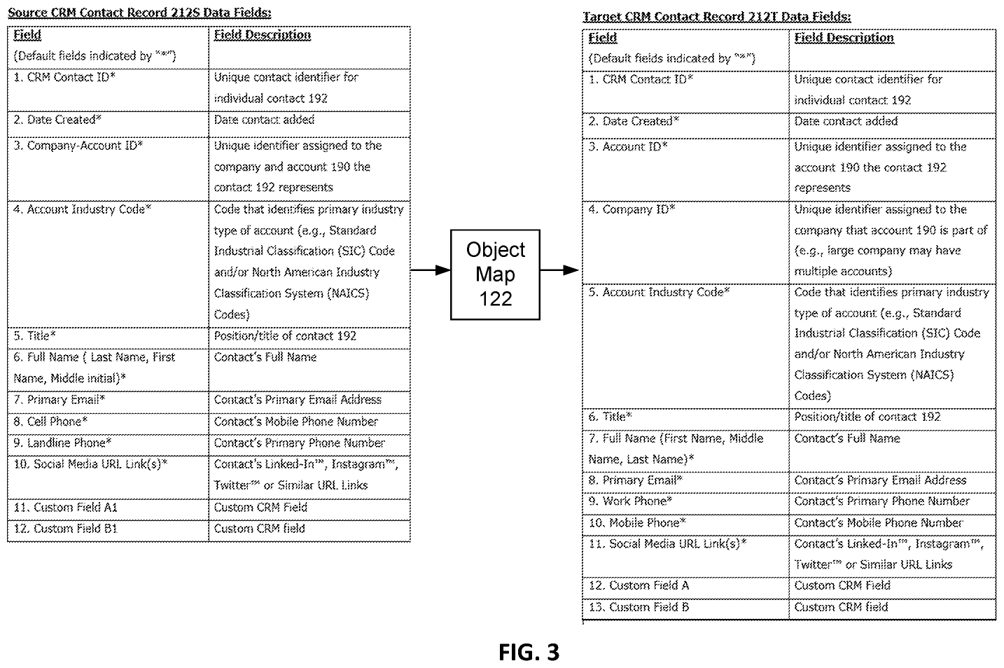

As can be seen by comparing Table 5 and 1, the source CRM contact record 212S format and the target CRM contact record 212T format include a number of similar default fields, but in a different order and with different field formats in some cases. The custom fields in the source and target formats may also include similar data or may be completely unrelated in some examples. FIG. 3 provides a side by-side comparison of the source and target record formats. As explained in greater detail below, migrations system 100 is configured to apply an object map 122 to map the attributes include in fields of source CRM contact record 212S to fields of the target CRM contact record 212T.

As indicated in FIG. 2, in at least some example embodiments, in addition to relationship data storage 102T, CRM support system also includes a relationship data storage 102S that includes support contact records 108S that correspond to the source CRM database contact records 212S. In at least example embodiments, the contact records 108S include the same set of default fields as contact records 108T. CRM support system 120 stores a CRM system 200S-CRM support system 120 attribute map 106S (hereafter “support map 106S”) that maps the fields of contact record 212S format to the corresponding fields of contact record 108S format, including custom fields. In some example embodiments, CRM support system 120 may have access to source relationship data storage 102S because the enterprise that was supported by source CRM system 200S has also been historically supported by the same or similar CRM support system 120. In some examples, relationship data storage 102S is created in anticipation of an upcoming contact data migration. In some examples, the migration may be performed without access to a source relationship data storage 102S.

In some example embodiments, the contact records 108S stored in relationship data storage 102S may not be specific to or limited to contacts that are included in the contact records 2121S of source CRM system 200S. Rather, contact records 108S stored in relationship data storage 102S may just be based on information collected in respect of potential contacts based on information available from third party data provider databases 280.

Referring again to FIG. 2, in example embodiments, the migration system 100 includes a filter module 116, mapping module 117 and data steward module 118. According to example embodiments, a CRM migration from source CRM system 200S to a target CRM system 200T is performed in accordance with a migration policy 114 stored in a migration policy database. The migration policy 114, which defines threshold criteria for one or more contact data attributes as described below, is applied by filter module 116. The source CRM system contact data that does not meet the defined migration policy value is not migrated to the target CRM system.

Mapping module 117 is configured to process source contact data that passes filter module 116. Mapping module 117 applies mapping policy/rules 120 and an object map 122, as described in greater detail below, to perform a data mapping process to migrate the data that has met the migration policy 114 from the source CRM system 200S to the target CRM system 200T. In example embodiments, data steward module 118 is configured to perform a user interface function and is called on by mapping module 117 to resolve unknown data mappings or ambiguities that may arise during the mapping process.

As indicated above, object maps 122 are applied to map the attributes included in fields of source CRM contact record 212S to fields of the target CRM contact record 212T. For the purposes of this example embodiment, an object map 122 is a pre-defined structure that identifies fields that are the same data in two different CRMs. As illustrated in FIG. 3, an example might be that source CRM system contact record 212S has a data field named “Company-Account ID” and this contains the exact same data that is divided into two fields, “Account ID” and “Company ID”, in target CRM system contact record 212T. The corresponding object map 122 may for example include a structure that divides the “Company-Account ID” included in field 3 of source CRM contact record 212S into a separate Company ID and Account ID that are respectively mapped to fields 4 and 3 of target CRM contact record 212T. In example embodiments, migration system 100 may have access to a set of preconfigured object maps 122, each of which is specific to mapping from one CRM system to a further CRM system. In example embodiments, object maps 122 can include default object maps 122D and customized object maps 122C. Default object maps 122D may be preconfigured maps that include mapping structures for mapping the default fields of a first known CRM system to those of a second known CRM system. For example, default object maps 122D could include maps for mapping the contact data included in the known default data fields of a CRM system from a known provider (example CRM provider B) to the known default data fields of a CRM system from a second known provider (example CRM provider A). Default object maps 122D could also include maps for mapping the contact data included in the known default data fields of a CRM system from a known provider (example CRM provider A) to default data fields of a CRM system from the same known provider (example CRM provider A). Accordingly, default object maps 122D could for example include: a default object map “CRM A=>CRM B” 122D for mapping the default fields of contact data from CRM system A to CRM system B; default object map “CRM A=>CRM C” 122D for mapping the default contact data fields from CRM system A to CRM system C. In some examples where migration of default contact data fields of CRM system A to CRM system A (“CRM A=>CRM A”) is performed, the respective default object map may just specify direct one to one fields, or may not be required.

In at least some example embodiments, a default object map 122D won't include mappings for custom fields. In such examples, as explained below, mapping module 117 may determine suggested mappings that can then be used to update defaults object maps 122D to provide a resulting customized object map 122C for future use. In some example embodiments, data steward module 118 is called to allow a data steward 400 (e.g., a decision-making authority or oracle such as a human user) to approve a suggested mapping that results in a customized object map 122C. In some examples, suggested mappings may be automatically accepted and applied to results in a customized object map 122C.

In example embodiments, mapping policy 120 specifies a set of rules for mapping contact data from source CRM database 210S to target CRM database 210T. For example, such rules could specify how duplicate contacts are to be handled. Duplicate contacts refers to a scenario where respective contact records 212S, 212T exist in both the source CRM system 200S and the target CRM system 200S for a contact who has been identified as being the same individual person. For example, mapping policy 230 could specify duplicate contact rules such as, but not limited to: (i) Ignore and do not migrate the source CRM contact record 212S; (ii) Migrate only fields from the source CRM contact record 212S that are not populated in the target CRM contact record 212S; or (iii) Use the most recent data available between the respective contact records 212S, 212T to populate target contact records 212T. In some examples, for example when the contact records 108S included in relationship data storage 108S is derived from sources other than source CRM contact records 212S, the mapping policy 230 could specify rules about what and how data from contact records 108S is to be merged with data from source CRM contact records 212S to provide resulting target CRM contact records 212T.

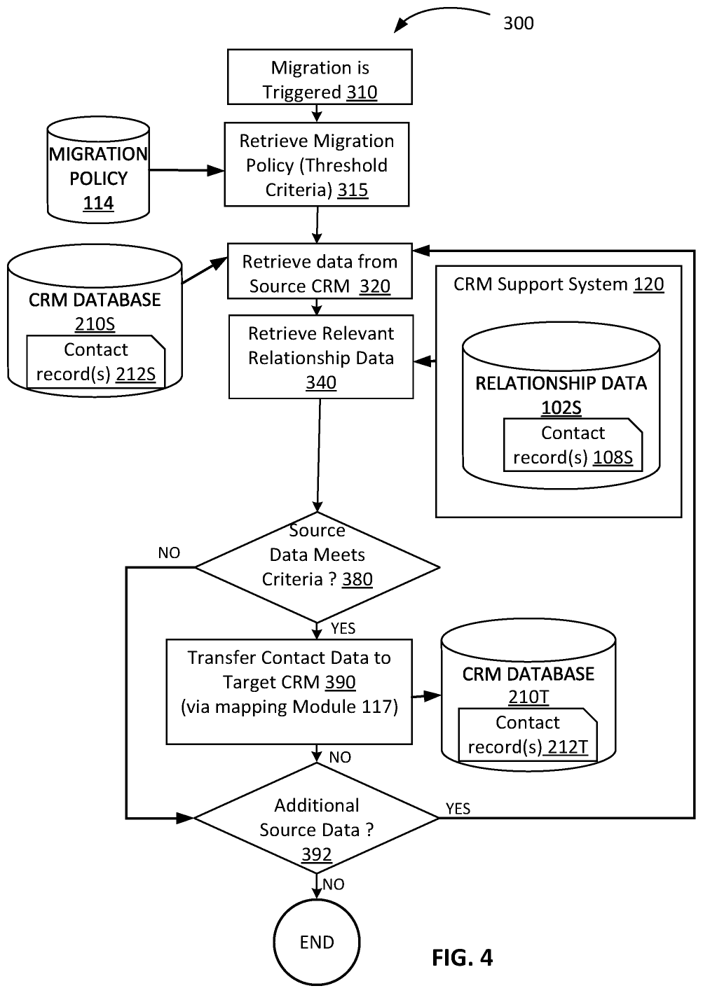

An example of a migration filtering process 300, performed by migration system 100 will now be explained with reference to FIG. 4. In an example embodiment, some or all of the actions indicated in FIG. 4 may be performed filter module 116.

The migration filtering process 300 is triggered (step 310) by an instruction from a user such as a system administrator or data steward 400, or by some other triggering event. The source CRM system 200S and target CRM system 220T are identified. In example embodiments, access to the data in such systems is facilitated through respective CRM agents 98.

In an example embodiment, the filter module 116 retrieves a migration policy 114 as shown in step 315. This migration policy 114 identifies threshold criteria for determining what source contacts (as represented in source contact records 212S) should be migrated to the target CRM system 200T. In an example embodiment, this criteria can be related to one or more of the following contact attributes, as well as other possible attributes: (i) a minimum relationship score (e.g., only migrate contact records 212S for contacts that meet a minimum relationship score); (ii) a minimum title score (e.g., only migrate contact records 212S for contacts that meet a minimum title score); (iii) a specific industry (e.g., only migrate contact records 212S that have an account industry code attribute that falls within a defined industry or set of industries); (iv) a specific organization (e.g., only migrate contact records 212S that have specific company ID and/or Account ID attribute(s)); (v) exclude specific organizations (e.g., exclude contact records 212S that have specific company ID and/or Account ID attribute(s)); (vi) minimum completeness score (e.g., only migrate contact records 212S that include a threshold level of contact information). In example embodiments, the migration policy may be a plurality or combination of pre-defined attribute standards. It will be noted that at least some of the above attributes comprise information that is available from the contact records 108S stored by CRM support system 120, but not in the contact records 212S stored by source CRM database 210S, such as relationship score and title score. Relationship score and title score are metrics that are indicative of a perceived value of the contact.

As illustrated in step 320, filter module 116 retrieves a source CRM contact record 212S from the source CRM database 210S in the source CRM system 200S. In the case where a corresponding CRM support contact record 108S is available, filter module 116 also retrieves the corresponding CRM support contact record 108S from relationship data storage 200S, as illustrated in step 340. As indicated in step 380, the filter module 116 then applies the criteria specified by migration policy to the attributes included in CRM contact record 212S and, if available, CRM support contact record 108S, to determine if the threshold criteria is met. In some examples where CRM support contact record 108S is not available, filter module 116 may be configured to compute values in respect of criteria that is not directly included in the source CRM contact record 212S, such as title score.

In the example embodiment, as illustrated by step 390 of FIG. 2, the filter module 116 will pass CRM contact records 212S that meet the migration policy 114 for migration processing for the target CRM system 200T. In at least some example embodiments, source CRM contact records 212S that meet the migration policy are provided to mapping module 117 for migration processing. As indicated in step 392, steps 320, 380 and 390 are repeated for all source CRM contact records 212S. In some examples, a set of source CRM contact records 212S are collected and provided to mapping module 117 for batch migration processing in step 390. In other examples, source CRM contact records 212S are provided one at a time to mapping module 117 for migration processing.

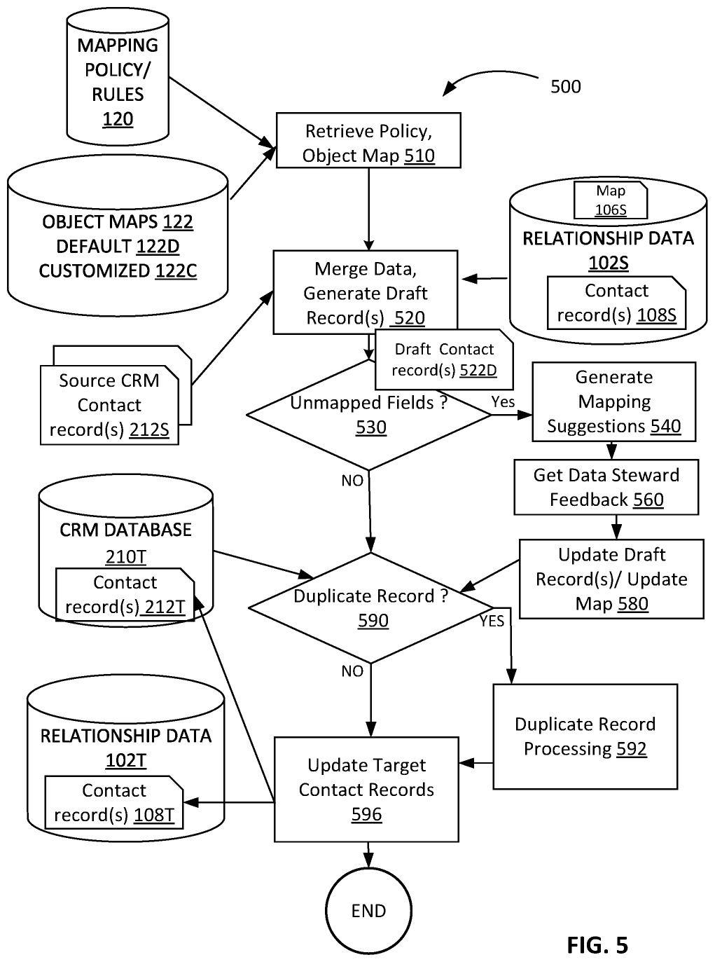

FIG. 5 is a flowchart illustrating a mapping process 500 that is performed by mapping module 117 according to example embodiments.

As indicated in step 510, mapping module 117 is configured to retrieve the mapping policy 120 and the default object map 122D that corresponds to a migration process in respect of source CRM system 200S to target CRM system 200T. As noted above, in example embodiments the migration system 100 may be configured with default object maps 122D that corresponds to specific CRM system to CRM system migration processes (e.g. CRM A=>CRM B migration, where A and B are respective known CRM solution providers). In some examples, a comprehensive (or any) default object map 122D may not exist in respective of specific CRM system-CRM system combination, in which case a default object map 122D may effectively be a null map.

As indicated in step 520, draft contact records are then generated, based on the mapping policy 120, default object map 122D, the source CRM contact records 212S that have passed the migration filtering process 300, and any information included in contact records 108S of source relationship data storage 102S.

In particular, in step 520, the attributes from the fields in each source CRM contact record 212 are mapped, according to the default object map 122D to fields of a corresponding draft record 522D that is formatted according to the format of a target contact record 212T. In some example embodiments, mapping module also references relationship data storage 102S to determine if any pertinent information is included in that data storage. As noted above, in some examples the contact records 108S stored in relationship data storage 102S may be directly derived from the source CRM contact records 212S, in which case records from the two sources can be matched by a source CRM Contact ID. However, in other examples, the contact records 108S stored in relationship data storage 102S may be general records obtained from third party data providers, in which case records from the two sources can be matched by using contact identity matching techniques, for example looking at fields such as email address, name and phone number to identify likely matches for the same individual contact.

Any relevant data available from contact records 108S for the same contacts as included in source CRM contact records(s) can be merged into the corresponding draft contact records 522D in accordance with mapping policy 120.

Accordingly, the output of step 520 is a set of one or more draft contact records 522D, each of which corresponds to a respective contact 192. The draft contact records 522D are formatted according to target CRM contact records 212T. As noted above, in example embodiments, some of the fields in each of the source CRM contact records 212S and target CRM contact records 212T may be custom fields that are not covered in default object map 122 and accordingly some fields included in the source CRM contact records 212S may not get mapped to fields in their corresponding draft contact records 522D. Furthermore, in some cases, an appropriate default object map 122D may not exist for the combination of CRM systems that is being merged, in which case all fields may remain unmapped. Accordingly, as part of step 520, mapping module 117 is configured to track data fields that are included in source contact record(s) 212s (and in some examples in contact records 108S) and not mapped to respective fields in draft contact record(s) 522D. In typical examples, the unmapped fields will be common to all the source contact records.

In this regard, in an example embodiment, at step 530 the mapping module 117 is configured to determine if unmapped fields exist. If so, an unmapped field suggestion process, comprising steps 540, 560, 580 is performed. If no unmapped fields exist, the mapping module 117 proceeds directly to a duplicate record decision step 590.

Regarding the unmapped field suggestion process, in example embodiments the mapping module 117 is configured to determine if an automated mapping suggestion can be generated (step 540). In one example embodiment, a possible field mapping may be determined by comparing support map 106S and support map 106T (both known by the CRM support system 120, and which may relate each of the source contact record 212S format and target contact record 212T format to a substantially common record format used by the CRM support system 120 for contact records 108S and 108T. In some examples, a possible field mapping may be determined by matching the format of the information included in the unmapped contact record fields of source contact record 212S with the format of the information included in the individual contact record fields of one or more of target contact record 212T, support system contact record 108S, and/or support system contact record 108T. Identification of field data formats that are identical or similar (e.g., have a threshold level of similarity as determined by a format matching algorithm) can then be used to provide mapping suggestions for the unmapped fields. In some embodiments, mapping suggestions may be based on matching identical or similar names of the fields in the respective contact records. For example, if the source CRM contact record 212S format includes a custom data field named “InstagramP” and if the target CRM contact record 212T format includes an data filed named “Instagram”, similarity matching by the mapping module 117 results in a suggestion that the field “InstragramP” the source CRM contact record 212S be mapped to the field “Instagram” in the target CRM contact record 212T for data migration purposes.

As indicated in step 560, in some example embodiments the mapping module 117 calls on data steward module 118 for user verification of a suggested field mappings (also referred to as object mapping), and in some examples, for mapping input in respect of unmapped fields for which no suggestion has been determined. In this regard, data steward module 118 is configured to present the suggested mappings to a decision making authority who can then determine an appropriate action to take in respect of the suggested mappings. In example embodiments, the decision making authority is an individual member (e.g., data steward 400) of the enterprise 180 who has been authorized to make decisions about contact data. In example embodiments, data steward module 118 is configured to generate an interactive user interface display for the data steward 400, using a display device. Based on presented information, which may for example, include fields names and sample data content of the source contact records 212S and target contact records 212T, data steward 400 can provide inputs indicating that mappings are suggested or rejected. In some examples, the data steward module 118 allows data steward to override and replace suggested mappings, and also to manually select mappings for unmapped fields where no mapping suggestions have been provided. Accordingly, in example embodiments, unmatched fields are sent to the data steward module 118 where they are presented to a data steward 400 for a manual field matching. The data steward 400 may also be presented with the recommendations that the mapping module 117 identified in step 530. As indicated in step 560, the mapping module 117 receives feedback from the data steward module 118 that may specify mappings for unmatched fields. As indicated in step 580, the mapping module 117 updates the draft contact records 522D based on the feedback. In example embodiments, any fields from source contact records 108S that do not have an approved mapping after data steward feedback are ignored and not migrated. Conversely, the data included in previously un-mapped fields for which mappings have been confirmed is used to populate the corresponding fields of draft contact records 522D. In at least some examples, the new mapping information is also used to update a default object map 122D into a customized object map 122C. The customized object map 122C can then be used for any future migrations that may involve CRM systems pairs that use the same formats as source contact record 212S format and target contact record 212T.

As indicated in step 590, mapping module 117 then applies a decision making step 590 in respect of each draft contact record 522D to determine if the draft contact record 522D corresponds to a target contact record 212T for the same individual contact. In example embodiments, mapping module 117 may apply a similarity matching algorithm based on one or more contact identifying fields (e.g, name, email address, phone numbers) of the draft contact record 522D and target contact records 212T (and/or contact records 108T) to determine if draft contact record 522D is a duplicate of an existing target contact record. If not, as indicated in step 596, mapping module 117 adds the draft contact record 522D as a new contact record 212T to CRM database 210T. In some examples, mapping module 117 also adds a corresponding contact record 108T to relationship data storage 102T.

In the event that in step 590 the draft contact record 522D is determined to be a duplicate record, the mapping nodule 117 process the draft contact record 522D and the corresponding target contact record 212T as specified by the rules of mapping policy 120, and if required the target contact record 212T is updated in target CRM database 210T (step 596), along with corresponding contact record 108T.

In an alternate embodiment, suggestions generated by the data mapping module 117 in step 540 are automatically applied in step 580 without input from a data steward module 118 (e.g., step 560 is omitted) and any fields not mapped at this point of the process are not migrated. This alternate embodiment removes the requirement for a data steward 400 to be involved.

Accordingly, in example embodiments the methods and systems may in some scenarios enable contact data from a source CRM system to be migrated to a target CRM system in a highly automated manner that requires limited or no human intervention. Source contact data can be filtered based on a number of different criteria. Mapping suggestions can be automatically generated and manually reviewed, if desired. The disclosed embodiments may improve computational efficiency and data accuracy in some data migration applications.

In example embodiments, the components, modules, systems and agents included in enterprise network 90, CRM support system 120 and CRM systems 200T and 200S can be implemented using one or more computer devices, servers or systems that each include a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a digital signal processor, or another hardware processing circuit.

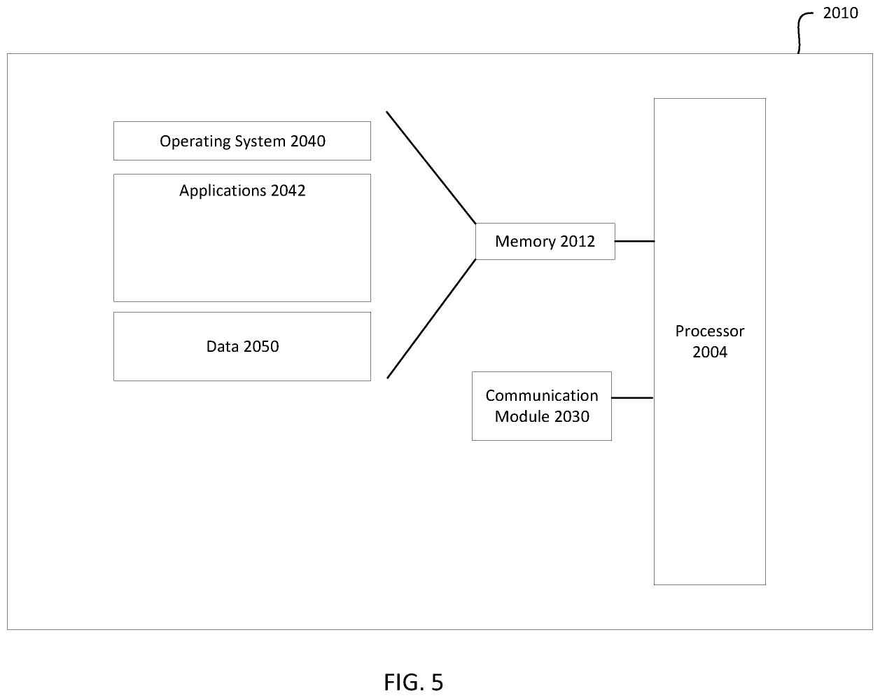

Referring to FIG. 6, an example embodiment of a computer system 2010 for implementing one or more of the modules, systems and agents included in enterprise network 90, CRM support system 120 and CRM systems 200T, 200S will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above.

The system 2010 is configured to store data that may include for example include contact records, migration policies, mapping policies and object maps data objects.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for migrating contact data from a source customer relationship management (CRM) system to a target CRM system that comprises a plurality of target contact records that each include a target set of data fields populated with information about a respective existing contact, comprising:
retrieving a source contact record corresponding to a source contact from a source CRM database associated with the source CRM system, the source contact record including a first set of data fields populated with information about the source contact;
retrieving, from a support database, a support contact record corresponding to the source contact, the support contact record including a second set of data fields populated with information about the source contact; and
determining, based on information included in the support contact record, if the source contact record meets a predefined migration criteria, and if so perform a migration process to migrate information included in the source contact record to the target CRM system.

2. The method of claim 1 wherein the predefined migration criteria includes one or more metrics that are indicative of a perceived value of the source contact.

3. The method of claim 2 wherein the metrics indicative of the perceived value of the source contact include one or both of (i) a threshold relationship score that indicates a perceived value of a relationship with the source contact based on a communication activities associated with the source contact, and (ii) a threshold title score that indicates a position of the source contact.

4. The method of claim 3 wherein one or both of a relationship score and a title score of the source contact are indicated in the support contact record.

5. The method of claim 1 wherein the predefined migration criteria include one or more of the following in respect of the source contact: (i) a minimum relationship score; (ii) a minimum title score; (iii) a specific industry to include for migration; (iv) a specific organization to include for migration; (v) a specific organization to exclude from migration; and (vi) a minimum completeness score for the first set of data fields.

6. The method claim 1 wherein the migration process comprises:
merging information from the first set of data fields and the second set of data fields in accordance with a predefined mapping policy that defines a set of predefined rules for mapping the source contact record to the target CRM system and a predefined object map, the predefined object map mapping at least some of the data fields of the first set of data fields to corresponding data fields of the target set of data fields; and
when the first set of data fields includes unmapped fields that have not been mapped to a corresponding data field in the target set of data fields:
automatically determining a suggested mapping for one or more of the unmapped fields;
presenting the suggested mapping to a data steward for approval; and
applying the suggested mapping as approved by the data steward to map at least one of the unmapped fields to a corresponding data field in the target set of data fields.

7. The method claim 6 wherein automatically determining the suggested mapping for one or more of the unmapped fields comprises matching unmapped fields to one or more data fields in the target set of data fields based on the format of the data included in the fields.

8. The method claim 6 wherein automatically determining the suggested mapping for one or more of the unmapped fields comprises matching unmapped fields to one or more data fields in the target set of data fields based on similarities in names of the fields.

9. The method of claim 6 wherein the migration process comprises determining if the source contact record corresponds to a target contact record that corresponds to an existing contact that is the same individual as the source contact, and if so, performing a duplicate record processing process in accordance with the predefined mapping policy.

10. A computer system comprising a processor and non-volatile storage storing computer instructions that when executed by the processor configure the computer system to migrate contact data from a source customer relationship management (CRM) system to a target CRM system that comprises a plurality of target contact records that each include a target set of data fields populated with information about a respective existing contact, wherein the computer system is configured to:
retrieve a source contact record corresponding to a source contact from a source CRM database associated with the source CRM system, the source contact record including a first set of data fields populated with information about the source contact;
retrieve, from a support database, a support contact record corresponding to the source contact, the support contact record including a second set of data fields populated with information about the source contact; and
determine, based on information included in the support contact record, if the source contact record meets a predefined migration criteria, and if so perform a migration process to migrate information included in the source contact record to the target CRM system.

11. The computer system of claim 10 wherein the predefined migration criteria includes one or more metrics that are indicative of a perceived value of the source contact.

12. The computer system of claim 11 wherein the metrics indicative of the perceived value of the source contact include one or both of (i) a threshold relationship score that indicates a perceived value of a relationship with the source contact based on a communication activities associated with the source contact, and (ii) a threshold title score that indicates a position of the source contact.

13. The computer system of claim 12 wherein one or both of a relationship score and a title score of the source contact are indicated in the support contact record.

14. The computer system of claim 10 wherein the predefined migration criteria include one or more of the following in respect of the source contact: (i) a minimum relationship score; (ii) a minimum title score; (iii) a specific industry to include for migration; (iv) a specific organization to include for migration; (v) a specific organization to exclude from migration; and (vi) a minimum completeness score for the first set of data fields.

15. The computer system of claim 10 wherein the migration process comprises:
merging information from the first set of data fields and the second set of data fields in accordance with a predefined mapping policy that defines a set of predefined rules for mapping the source contact record to the target CRM system and a predefined object map, the predefined object map mapping at least some of the data fields of the first set of data fields to corresponding data fields of the target set of data fields; and
when the first set of data fields includes unmapped fields that have not been mapped to a corresponding data field in the target set of data fields:
automatically determining a suggested mapping for one or more of the unmapped fields;
presenting the suggested mapping to a data steward for approval; and
applying the suggested mapping as approved by the data steward to map at least one of the unmapped fields to a corresponding data field in the target set of data fields.

16. The computer system of claim 15 wherein automatically determining the suggested mapping for one or more of the unmapped fields comprises matching unmapped fields to one or more data fields in the target set of data fields based on the format of the data included in the fields.

17. The computer system of claim 15 wherein automatically determining the suggested mapping for one or more of the unmapped fields comprises matching unmapped fields to one or more data fields in the target set of data fields based on similarities in names of the fields.

18. The computer system of claim 15 wherein the migration process comprises determining if the source contact record corresponds to a target contact record that corresponds to an existing contact that is the same individual as the source contact, and if so, performing a duplicate record processing process in accordance with the predefined mapping policy.

19. A non-volatile digital storage medium storing computer instructions that when executed by a processor configure the processor to migrate contact data from a source customer relationship management (CRM) system to a target CRM system that comprises a plurality of target contact records that each include a target set of data fields populated with information about a respective existing contact, wherein the instructions include instructions to:
retrieve a source contact record corresponding to a source contact from a source CRM database associated with the source CRM system, the source contact record including a first set of data fields populated with information about the source contact;
retrieve, from a support database, a support contact record corresponding to the source contact, the support contact record including a second set of data fields populated with information about the source contact; and
determine, based on information included in the support contact record, if the source contact record meets a predefined migration criteria, and if so perform a migration process to migrate information included in the source contact record to the target CRM system.
